(19) United States
(12) Patent Application Publication
(10) Pub. No.: US 2026/0099198 A1
(43) Pub. Date: Apr. 9, 2026

(54) SMART GLASSES WITH FACIAL EXPRESSION DETECTION

(71) Applicant: Robert Bosch GmbH, Stuttgart (DE)

(72) Inventors: Johannes Meyer, Haseluenne (DE); Thomas Alexander Schlebusch, Renningen (DE)

(21) Appl. No.: 19/113,699

(22) PCT Filed: Jan. 16, 2024
(86) PCT No.: PCT/EP2024/050895

§ 371 Date: Mar. 20, 2025

(30) Foreign Application Priority Data
Feb. 10, 2023 (DE) 10 2023 201 082.8

(51) Int. Cl. G06F 3/01

(52) U.S. Cl. CPC G06F 3/012

(57) ABSTRACT

A device, in particular smart glasses, which, when worn by a user as intended, is configured to be worn on the body of the user, in particular the head of the user, and a method for operating such a device. The device is configured to use reflected laser radiation to derive information about a reference area, and to provide the information about the reference area for the purpose of displaying a virtual target object, in particular an avatar that represents the user of the device, in particular to a further device.

### FIELD

The present invention relates to a device, in particular smart glasses, which, when worn by a user as intended, is configured to be worn on the body of the user, in particular the head of the user, and to a method for operating such a device.

The present invention also relates to a communication system comprising such a device and communication method.

### BACKGROUND INFORMATION

Camera-based systems for capturing a face or parts of a face are described in the related art, wherein the face is captured by means of a camera and the captured image data is evaluated using image processing methods, for example based on a neural network, in order to identify so-called facial landmarks in the captured image data and from said data derive information, for example about facial expressions.

Such camera-based systems are characterized by a corresponding required installation space and comparatively high power consumption. The functionality of cameras can moreover be limited if there is too much light coming in.

An object of the present invention is to provide a device of the aforementioned type that overcomes the stated disadvantages.

### SUMMARY

One embodiment of the present invention relates to a device, in particular smart glasses, which, when worn by a user as intended, is configured to be worn on the body of the user, in particular the head of the user, wherein the device comprises at least one laser feedback interferometer (LFI) sensor with at least one laser light source, in particular a laser diode, wherein the LFI sensor is disposed on the device and is configured to emit laser radiation into a reference area in a first area of a face outside the eyes of the user of the device and to capture a reflected portion of the laser radiation, and wherein the device is configured to use the reflected portion of the laser radiation to derive information about the reference area,

and wherein the device is configured to provide the information about the reference area for the purpose of displaying a virtual target object, in particular an avatar that represents the user of the device, in particular to a further device.

According to the an example embodiment of the present invention, it is provided that the LFI sensor is configured to emit laser radiation into the reference area. This means that the LFI sensor thus illuminates the reference area at least partially or almost completely or completely. The reference area is illuminated, for example, by illuminating the entire reference area or by illuminating several discrete reference points within the reference area.

Both by illuminating the entire reference area and by illuminating several discrete reference points within the reference area, the device, in particular the acquisition of the reflected laser radiation and/or the derivation of the information, can be robust to movement of the glasses. The acquisition and derivation also becomes more robust with respect to different head geometries of different users.

A laser feedback interferometer (LFI) sensor is a sensor that is configured to emit laser radiation by means of a laser light source and to capture reflected laser radiation or an associated variable.

According to an example embodiment of the present invention, the evaluation of the backscattered and/or reflected radiation is particularly advantageously carried out on the basis of optical feedback interferometry. The measurement principle underlying the method is preferably based on the method that is also referred to as self-mixing interference (SMI). Laser radiation is reflected by an object, for example the reference area, and scattered or reflected back into the laser cavity that generates the laser. The reflected light then interferes with the beam generated in the laser cavity, i.e. primarily with a corresponding standing wave in the laser cavity, which results in changes in the optical and/or electrical properties of the laser. This typically leads to intensity fluctuations in the output power of the laser. Analyzing these changes can provide information about the object, for example the reference area at which the laser radiation was reflected or scattered.

To understand the principle, it is first explained using a single point at which the laser beam is scattered and/or reflected. If the twice the distance between the LFI sensor and the object, for example the point at which the radiation is scattered and/or reflected, is an integer multiple of the wavelength of the laser radiation, the scattered or reflected radiation and the radiation in the LFI sensor are in phase. This leads to positive/constructive interference, as a result of which the laser threshold is lowered and the laser output is increased slightly. At a distance is slightly greater than an integer multiple, the two radiation waves are out of phase and negative interference occurs. The laser output power is reduced. If the distance between the LFI sensor and the object, for example the reference point at which the radiation is scattered and/or reflected, is changed at a constant speed, the laser output fluctuates between a maximum with constructive interference and a minimum with destructive interference. The resulting oscillation is a function of the speed of the object, for example the reference point, and the laser wavelength.

The speed of the object can be determined by analyzing the amplitude in the frequency range, for instance. In an example of a simple case with constant movement of a reference point relative to a LFI sensor without modulation of the laser light source of the LFI sensor, i.e. the wavelength and frequency of the laser are not changed over time, a peak frequency, also a center frequency, in the amplitude/frequency range spectrum of the LFI sensor correlates directly with the speed component in beam direction.

In another example of a simple case with constant movement of a reference point relative to a LFI sensor, the peak frequency shifts up or down, or correspondingly to the left or right in the amplitude/frequency range spectrum of the LFI sensor. The shift direction depends on the modulation ramp with which the laser is being operated, up or down, and the direction of the speed vector with which the reference point moves in relation to the LFI sensor, toward the LFI sensor or away from the LFI sensor. The distance between the peak frequencies can be used to determine the direction and absolute value of the movement of the reference point.

A similar effect occurs with an object that is moving parallel to the emitted laser beam, for example a reference point, at which the laser radiation is scattered and/or reflected. Due to the Doppler effect, this causes a change in the frequency of the backscattered laser light. At low speeds this can be approximated as a phase shift of the backscattered laser light in the laser cavity and thus, analogously to the described effect, leads to oscillating oscillations of positive and negative interference, namely to the formation of a beat frequency f_{b}. The distance dependent beat frequency f_{b} can be ascertained using a Fast Fourier Transformation (FFT).

If a reference area is illuminated, multiple frequencies are superimposed on the portion of the laser radiation reflected in the reference area. This can in principle be viewed as a reflection at multiple points within the reference area. This superposition leads to a spectral distribution in the distance spectrum. Likewise, there is a speed spectrum containing Doppler frequencies f_{d}. If different points within the reference area move at different speeds, a superposition in the spectrum can be observed here as well. The superposition of the Doppler frequencies f_{d} in the spectrum is referred to hereinafter as a speed spectrum.

The distance and speed spectra can thus be used to derive information about the reference area based on the reflected portions of the laser radiation. Information about the reference area includes positions of discrete reference points in the reference area, for example, for instance an absolute position of reference points or a relative position of reference points to the LFI sensor. Alternatively or additionally, a change in the positions of the reference points and/or a speed of a change in the positions of the reference points and/or a change in speed can be derived as well. A topology of the reference area relative to the LFI sensor and/or a change in the topology or a speed at which the change in the topology occurs can also be derived. A topology is understood to be the position and/or arrangement of the reference area as a geometric shape in relation to the LFI sensor.

The information about the reference area can be used to identify a shape of an area of the user's face and thus a facial expression and/or changes in the shape of the area of the user's face, and consequently movements in the area of the user's face and a change in the facial expression of the user.

In a preferred example embodiment of the method according to the present invention or the device according to the present invention, a surface emitter is used as the laser diode. A surface emitter, also referred to as a vertical cavity surface-emitting laser (VCSEL), has a variety of advantages over an edge emitter. Above all, a VCSEL requires very little space, in particular a sensor installation space of <200×200 μm, so that such a laser beam generation unit is particularly suitable for miniaturized applications. A VCSEL is also relatively inexpensive compared to conventional edge emitters and only has a low energy requirement. With respect to the measurement principle underlying the method according to the invention and also with respect to the use of VCSEL for miniaturized applications, reference is made to the paper by Pruijmboom et al. “VCSEL-based miniature laser-Doppler interferometer” (Proc. of SPIE Vol. 6908, 69080I-1-7).

In the case of a vertical cavity surface-emitting laser (VCSEL), the mirror structures are embodied as distributed Bragg reflectors (DBR). On one side of the laser cavity, the DBR reflector has a transmittance of about 1%, so that the laser radiation can couple out into free space.

In a particularly preferred example embodiment of the method according to the present invention, a surface emitter unit is used, which comprises an integrated photodiode or possibly a plurality of photodiodes and is also referred to as ViP (VCSEL (vertical cavity surface-emitting laser) with integrated photodiode). The integrated photodiode can be used to directly analyze the backscattered or reflected laser light that interferes with the standing wave in the laser cavity. When manufacturing a corresponding surface emitter unit, the photodiode can be integrated directly during production of the laser diode, which is produced as a semiconductor component in the course of semiconductor processing, for instance.

In the case of a ViP, the photodiode is disposed on the other side of the laser resonator, so that the photodiode does not interfere with the coupling into free space. A special feature of the ViP is the direct integration of the photodiode into the lower Bragg reflector of the laser. The size is therefore largely determined by the lens being used, which enables sizes of the laser/photodiode unit <2×2 mm. The ViP can thus be integrated, for instance into smart glasses, in such a way that it is almost invisible to the user.

According to one example embodiment of the present invention, it is provided that the LFI sensor comprises at least one optical element which is configured to expand a laser beam emitted by the laser light source at least along a line. The reference area extends along a line, for instance, so that the LFI sensor illuminates the reference area at least along the line by expanding the laser radiation. A line is understood to be a line that extends along a straight line. A line can alternatively also be a line that is curved or bent once or repeatedly. The expansion can also be in two or more directions. It is possible to create an illumination area having virtually any geometric shape, for instance. An illumination area can have a rectangular or approximately rectangular shape, for example, a circular shape, an elliptical shape, or any other shape. An optical element for expanding the laser beam is a lens, for example, in particular a cylinder lens or a diffractive optical element (DOE) or a holographic optical element (HOE).

According to another example embodiment of the present invention, illumination of the reference area means that the LFI sensor illuminates the reference area at least partially, namely in such a way that a laser beam emitted by the laser light source of the LFI sensor is split into at least two, in particular several, discrete subbeams, so that at least two discrete reference points within the reference area are illuminated. According to one embodiment, it is provided that the LFI sensor is configured such that a laser beam emitted by the laser light source is split into at least two, in particular several, discrete subbeams, so that at least two discrete reference points within the reference area are illuminated. Light is scattered and/or reflected at each of these reference points, so that a scattered and/or reflected portion of the subbeams is captured by the LFI sensor, which results in a superposition in the distance spectrum and/or speed spectrum. This in principle makes it possible to scan multiple discrete reference points within the reference area. A diffractive optical element (DOE), for example, or a holographic optical element (HOE), can be provided to split the laser beam into discrete subbeams. The beam can alternatively also be split by scanning the reference points using a scanning process. Examples of scanners include a microscanner comprising a movable single mirror, also known as a MEMS, or a surface light modulator comprising a mirror matrix, also known as SLM, or a reflection system based on LCOS (liquid crystal on silicon) (a technique for or an optical phase shifter.

According to one example embodiment of the present invention, it is provided that the device is configured such that discrete reference points can be illuminated according to at least one first illumination pattern and at least one second illumination pattern, and it is possible to switch between the first illumination pattern and the second illumination pattern. A diffractive optical element (DOE), or a holographic optical element (HOE), for instance, can be switched between different states using electronically controllable liquid crystal. The scanners can also be used to generate different illumination patterns by controlling them accordingly.

According to an advantageous embodiment of the present invention, it is provided that the device comprises at least two or more laser feedback interferometer (LFI) sensors. In this case, it can, for example, be provided that two or more LFI sensors are disposed and configured on the device for emitting laser radiation in the direction of two or more respective reference areas in the first area of the face and/or in further areas of the face.

The first area and/or the at least one further area is an area in the face of the user, for example a cheek region, in particular in the right or left half of the face, or an eyebrow region, in particular in the right or left half of the face, or a nose region, or a chin region, or a mouth region, or an eyelid region, in particular in the right or left half of the face.

According to an example embodiment of the present invention, the device comprises at least one control device, for instance, or a plurality of control devices, for controlling the at least one LFI sensor or for controlling a plurality of LFI sensors. Controlling includes switching the LFI sensor and/or the laser light source of the LFI sensor on or off, for example. An LFI sensor, in particular the laser light source of the LFI sensor, can be controlled to emit laser radiation at a modulated frequency, for instance.

According to an example embodiment of the present invention, the device comprises at least one computing device, for example, for deriving information about the reference area or reference areas using the reflected portion of the laser radiation. It is also possible that a plurality of computing devices are provided.

According to an example embodiment of the present invention, the device is configured to provide the information about the reference area for the purpose of displaying a virtual target object, in particular an avatar that represents the user of the device, in particular to a further device. The device itself can also be configured to display the virtual target object. The device can also be configured to specify the facial expressions of the virtual target object based on information about the reference area or the reference areas. The virtual target object is a virtual rendering of the user's face, for example.

The virtual target object can be displayed using a variety of techniques. For instance, the virtual target object can be projected onto a display or a glass of the device, in particular the smart glasses, for example by means of a laser. It is also possible that the virtual target object is projected into the field of view of the user of the device directly onto the retina of the eye of the user.

According to one example embodiment of the present invention, the device can be configured to provide the information about the reference area or the reference areas to a further device. The device comprises a communication interface suitable for this purpose, for example.

According to one example embodiment of the present invention, it is provided that the device is configured to receive data of a further device of a further user, in particular smart glasses. The data is received via a suitable communication interface, for example. The data to be received comprises information about at least one reference area in at least a first area of a face of the further user. The device is configured to display a virtual target object, in particular an avatar representing the further user, based on the data of the further device. The virtual target object is displayed by projecting the virtual target object, for instance; for example onto a display or a glass of the device or into the field of view of the user of the device directly onto the retina of the eye of the user. The information about the reference area includes information about positions of discrete reference points in the reference area and/or information about their changes and/or information about a topology of the reference area and/or its changes. This information can then be used to identify a shape of an area of the user's face and thus a facial expression and/or changes in the shape of the area of the user's face, and consequently movements in the area of the user's face and a change in the facial expression of the user. The device is configured to specify the facial expressions of the virtual target object based on the data of the further device. The virtual target object is a virtual rendering of the further user's face, for example.

According to one example embodiment of the present invention, it is provided that the device is configured such that specifying the facial expression of the virtual target object comprises: modulating at least one spline in a first area of the virtual target object based on the information about at least one reference area of the first area. The positions of discrete reference points in the reference area can be used to modulate positions of anchor points, for example, and a spline can be modulated based on the anchor points. The anchor points serve as nodes of the spline, for instance. Alternatively, a position of anchor points, or also directly a spline, can be ascertained or modulated using a distance spectrum and/or speed spectrum ascertained based on the reflected portion of the laser radiation captured by the at least one LFI sensor.

Further embodiments relate to a method for operating a device according to the embodiments. The method comprises the following steps:
emitting laser radiation into at least one reference area in a first area of a face of a user of the device and capturing a reflected portion of the laser radiation,
using the reflected portion of the laser radiation to derive information about a reference area,
providing the information about the reference area for the purpose of displaying a virtual target object, in particular an avatar that represents the user of the device, in particular to a further device.

The laser radiation is emitted at a modulated frequency. The information about the reference area is derived as described above using a distance spectrum and/or speed spectrum ascertained based on the reflected portion of the laser radiation captured by the at least one LFI sensor.

According to one example embodiment of the present invention, it is provided that the method comprises: receiving data from a further device of a further user, in particular smart glasses, wherein the data comprises information about at least one reference area in at least a first area of a face of the further user, and displaying a virtual target object, in particular an avatar that represents the further user, on the device based on the data of the further device, and providing a facial expression of the target object based on the data of the further device.

According to one example embodiment of the present invention, it is provided that, specifying the facial expression of the avatar comprises: modulating at least one spline in at least a first area of the virtual target object based on the information about the reference area of the first area.

According to one example embodiment of the present invention, it is provided that a respective reference area is assigned to or associated with at least one spline of the virtual target object, and a respective spline is modulated based on the information about the respective reference area.

According to one example embodiment of the present invention, it is provided that a distance spectrum and/or speed spectrum ascertained based on the reflected portion of the laser radiation captured by means of the at least one LFI sensor is made available as input data to at least one trained neural network and information about the reference area or information about a spline assigned to the respective reference area is derived from the distance spectrum and/or from the speed spectrum by means of the trained neural network, and the spline of the virtual target object is modulated based on the derived information. It can also be provided that at least one spectrum is respectively captured by means of at least two LFI sensors, wherein each spectrum is assigned to a reference point in an area of the user's face, and the spectra of the LFI sensors are arranged in a matrix-like manner along the frequency axis and/or the time axis one above the other and/or next to one another and are made available as input data to a trained neural network, and information about the respective reference area is derived from the spectra arranged in a matrix-like manner by means of the trained neural network.

According to one example embodiment of the present invention, it is provided that the method comprises a learning phase for adapting the trained neural network to a user of the device, wherein the neural network is adapted to the user using a camera, wherein image data recorded with the camera are used as labeled training data for adapting the neural network.

Further embodiments relate to a communication system comprising at least one first device and at least one further device, wherein the first and the further device are configured according to one of example embodiments disclosed herein, and wherein the first and the further device are configured to carry out a method according to one of example embodiments disclosed herein.

Further embodiments relate to a communication method between at least two users via a communication network comprising a communication system, wherein the first user is connected to the communication network via a first terminal and the second user is connected to the communication network via a second terminal, wherein the first terminal and the second terminal are each a device according to of the example embodiments disclosed herein, and wherein at least the first user is displayed as a virtual target object, in particular an avatar that represents the first user, on the second terminal of the second user.

Further advantages will emerge from the description and the figures. Embodiment examples of the present invention are shown in the figures and explained in more detail in the following description. The same reference signs in different figures respectively refer to the same elements or to elements that are at least comparable in terms of their function. In the description of individual figures, reference may also be made to elements in other figures.

### BRIEF DESCRIPTION OF THE DRAWINGS

FIG. 1 shows an example embodiment of a device according to the present invention when worn as intended on the head of a user.

FIG. 2 shows a section of the device according to FIG. 1.

FIG. 3 shows a section of a device according to another example embodiment of the present invention.

FIG. 4 shows an example amplitude/frequency range spectrum of a LFI sensor during movement without modulation of a laser light source of the LFI sensor.

FIG. 5 shows an example amplitude/frequency range spectrum of a LFI sensor during movement with modulation of a laser light source of the LFI sensor.

FIG. 6A shows an example diagram of a ramp-like modulation of a current operating a laser light source of a LFI sensor.

FIG. 6B shows an example graph of the output power of the laser light source, and a corresponding frequency shift.

FIG. 7 shows various components of a device according to an example embodiment of the present invention.

FIG. 8A-8D show a principle of operation of the LFI sensor for deriving information from reflected laser radiation, according to an example embodiment of the present invention.

FIG. 9 shows the device according to FIG. 1 and a virtual object that is displayed, for example by means of the device or by means of a further device.

FIG. 10 shows a section from FIG. 9.

FIG. 11 shows an embodiment example of a neural network with schematically depicted input data of the neural network, according to the present invention.

FIG. 12 shows another embodiment of schematically depicted input data of the neural network, according to the present invention.

FIG. 13 shows a communication system for carrying out a communication method with at least two users.

### DETAILED DESCRIPTION OF EXAMPLE EMBODIMENTS

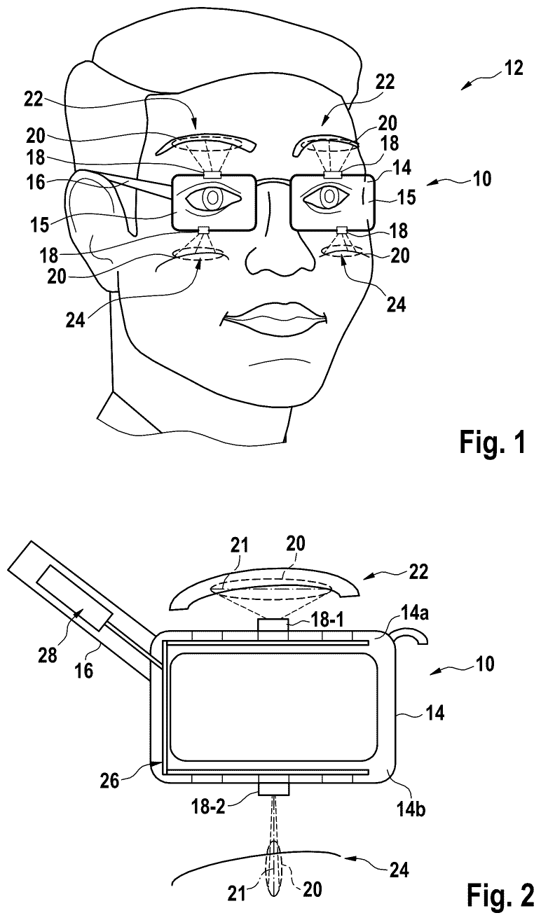

FIG. 1 shows a device 10, in particular smart glasses, which are being worn in an example of being worn as intended by a user 12 of the device 10 on the head of the user 12. According to the shown embodiment, the smart glasses 10 comprise a frame 14 that includes two lenses 15 and two side pieces 16.

The device 10 comprises at least one laser feedback interferometer (LFI) sensor 18 with at least one laser light source. A plurality of LFI sensors 18, four in total, are shown in this example.

The LFI sensors 18 are disposed on the device 10 and are configured to emit laser radiation into a reference area 20 in an area 22, 24 of the face outside the eyes of the user 12 of the device 10 and to capture a reflected portion of the laser radiation. The laser radiation is purely schematically indicated by the dashed lines.

In the example, a LFI sensor 18 for emitting laser beams in the direction of a first area 22, in the example an eyebrow region, in the face of the user 12 is configured on each half of the face. In the example, a further LFI sensor 18 for emitting laser beams in the direction of a further area 24, in the example a cheek region, in the face of the user 12 is configured on each half of the face. Example areas are the cheek region, in particular in the right or left half of the face, or an eyebrow region, in particular in the right or left half of the face, or a nose region, or a chin region, or a mouth region, or an eyelid region, in particular in the right or left half of the face.

A laser feedback interferometer (LFI) sensor 18 is a sensor that is configured to emit laser radiation by means of a laser light source and to capture reflected laser radiation or an associated variable.

The evaluation of the backscattered and/or reflected radiation is particularly advantageously carried out on the basis of optical feedback interferometry. The measurement principle underlying the method is preferably based on the method that is also referred to as self-mixing interference (SMI). A laser beam is reflected by an object and scattered or reflected back into the laser cavity that generates the laser. The reflected light then interferes with the beam generated in the laser cavity, i.e. primarily with a corresponding standing wave in the laser cavity, which results in changes in the optical and/or electrical properties of the laser. This typically leads to intensity fluctuations in the output power of the laser. Analyzing these changes can provide information about the object at which the laser beam was reflected or scattered.

To understand the principle, it is first explained using a single reference point, for example a discrete reference point located in the reference area.

If the twice the distance between the LFI sensor 18 and the object, for example the reference point in the reference area 20 at which the radiation is scattered and/or reflected, is an integer multiple of the wavelength of the laser radiation, the scattered or reflected radiation and the radiation in the LFI sensor are in phase. This leads to positive/constructive interference, as a result of which the laser threshold is lowered and the laser output is increased slightly. At a distance is slightly greater than an integer multiple, the two radiation waves are out of phase and negative interference occurs. The laser output power is reduced. If the distance between the LFI sensor 18 and the object, for example the reference point at which the radiation is scattered and/or reflected, is changed at a constant speed, the laser output fluctuates between a maximum with constructive interference and a minimum with destructive interference. The resulting oscillation is a function of the speed of the object, for example the reference point 20, and the laser wavelength.

The speed of the object can be determined by analyzing the amplitude in the frequency range, for instance. In an example of a simple case with constant movement of a reference point relative to a LFI sensor without modulation of the laser light source of the LFI sensor, i.e. the wavelength and frequency of the laser are not changed over time, a peak frequency, also a center frequency, in the amplitude/frequency range spectrum of the LFI sensor correlates directly with the speed component in beam direction. FIG. 4 shows an example amplitude/frequency range spectrum of a LFI sensor 18 during constant movement of the reference point relative to the LFI sensor without modulation of the laser light source of the LFI sensor. FIG. 4 shows the amplitude A over the frequency f. The peak frequency, also the center frequency, f1 is directly correlated with the speed component in beam direction.

Alternatively, the current that drives the laser light source of the LFI sensor 18 can be modulated in a ramp-like manner, which also modulates the wavelength of the laser radiation. If the distance between the LFI sensor 18 and the object, for example the reference point at which the laser radiation is scattered and/or reflected, is fixed, the number of wavelengths that “fit” into the optical path also changes, so that the above-described oscillating temporal interference pattern occurs as well. If then the optical radiant output is recorded, for example measured using a photodiode, the change in amplitude of the radiant output can be used to deduce the change in intensity of the backscattered laser output. Analyzing the number of oscillations, for example by counting the zero crossings or the maximum values or by calculating a Fourier spectrum using FFT and analyzing the amplitude in the frequency range, also makes it possible to deduce the number of oscillations, namely crossings of constructive and destructive interference, and thus, if the laser wavelength is known, also the distance between the LFI sensor 18 and the object, for example the reference point, at which the laser radiation is scattered and/or reflected.

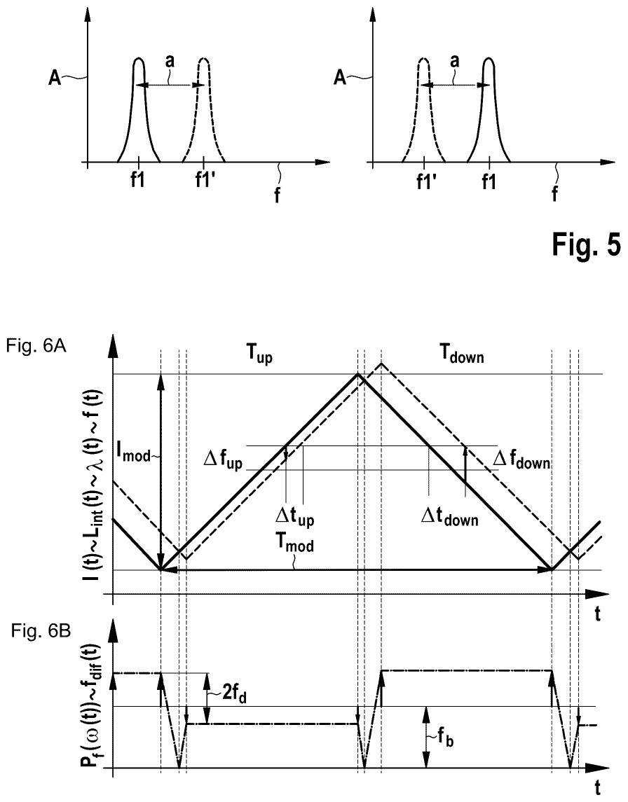

An example amplitude spectrum for modulated operation is shown in FIG. 5. Without movement of the object, a spectrum like that in FIG. 4 would result. The spectrum shown in FIG. 4 is also referred to as a distance spectrum. One the other hand, if the object at which the laser radiation is being reflected moves at a constant speed, a spectrum like that in FIG. 5 results. FIG. 5 shows the spectrum with a superimposed Doppler frequency. The superposition of the Doppler frequencies is also referred to as a speed spectrum. In this case, the distance between LFI sensor and object can be determined via the peak frequency f1, f1′. With additional movement of the object, the peak frequency f1, f1′ shifts up or down, cf. to the left or to the right in FIG. 4. The shift direction depends on the modulation ramp with which the laser is being operated, up or down, and the direction of the speed vector with which the object moves in relation to the LFI sensor, toward the LFI sensor or away from the LFI sensor.

FIG. 5 shows the two spectra for falling and rising modulation ramps (left and right). The distance a between the peak frequencies can be used to determine the direction and absolute value of the movement of the object.

A similar effect occurs with an object that is moving parallel to the emitted laser beam, for example the reference point, at which the laser radiation is scattered and/or reflected. Due to the Doppler effect, this causes a change in the frequency of the backscattered laser light. At low speeds this can be approximated as a phase shift of the backscattered laser light in the laser cavity and thus, analogously to the described effect, leads to oscillating oscillations of positive and negative interference, namely to the formation of a beat frequency f_{b}. This beat frequency f_{b} is directly proportional to the speed of the moving object, for example the reference point, at which the laser radiation is scattered and/or reflected. The speed of light c₀, the angle a between the laser beam and the movement vector, and the exciting laser frequency f₀ are known. The speed of the object can then be determined via the beat frequency f_{b} with f_{b}=2 v/c₀*f₀ cos (a).

The distance-dependent beat frequency f_{b} can be ascertained by a FFT using the triangular modulated output power of the laser, see FIGS. 6A and 6B.

The Doppler frequency _{fd} can likewise be ascertained by a FFT using the triangular modulated output power of the laser, see FIGS. 6A and 6B.

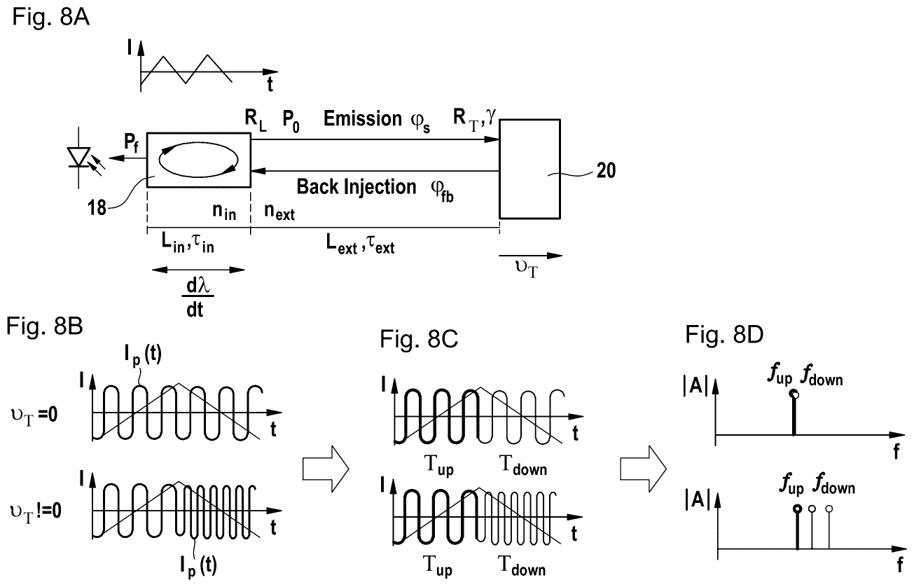

The time signal of the measured photocurrent Iₚ(t) is segmented using the modulation signal, in this case triangular ramps. In the example, the segments are referred to as segment Tᵤₚ and segment T_{down}, see FIG. 8C.

The FFT is then applied to the respective segment Tᵤₚ and segment T_{down} comprising the time series data Iₚ(T), see FIG. 8D.

f_{b} and f_{d} are calculated according to the following mathematical relationships, for example:

$${f}_{b} = \frac{{f}_{up} + {f}_{down}}{2} and {f}_{d} = \frac{{f}_{up} - {f}_{down}}{2} ,$$

wherein

$${f}_{b} = \frac{2 {L}_{ext}}{{λ}^{2}} \frac{dλ}{dt} and {f}_{d} = \frac{2 {v}_{T}}{λ}$$

can be used to ascertain the speed V_{T} of the reference point 20 or the distance Lₑₓₜ of the reference point 20 to the LFI sensor 18.

If a reference area 20 is illuminated, multiple frequencies are superimposed on the portion of the laser radiation reflected in the reference area 20. This can in principle be viewed as a reflection at multiple points within the reference area 20. This superposition leads to a spectral distribution in the distance spectrum. Likewise, there is a speed spectrum containing Doppler frequencies f_{d}. If different points within the reference area 20 move at different speeds, a superposition in the spectrum can be observed here as well. The superposition of the Doppler frequencies f_{d} in the spectrum is referred to hereinafter as a speed spectrum.

The distance and speed spectra can thus be used to derive information about the reference area 20 based on the reflected portions of the laser radiation. Information about the reference area 20 includes positions of discrete reference points in the reference area 20, for example, for instance an absolute position of reference points or a relative position of reference points to the LFI sensor 18. Alternatively or additionally, a change in the positions of the reference points and/or a speed of a change in the positions of the reference points and/or a change in speed can be derived as well. A topology of the reference area 20 relative to the LFI sensor 18 and/or a change in the topology or a speed at which the change in the topology occurs can also be derived. A topology is understood to be the position and/or arrangement of the reference area 20 as a geometric shape in relation to the LFI sensor 18.

The information about the reference area 20 can then be used to identify a shape of an area of the user's face and thus a facial expression and/or changes in the shape of the area of the user's face, and consequently movements in the area of the user's face and a change in the facial expression of the user.

In a preferred embodiment of the method according to the invention or the device according to the invention, a surface emitter is used as the laser diode. A surface emitter, also referred to as a vertical cavity surface-emitting laser (VCSEL), has a variety of advantages over an edge emitter. Above all, a VCSEL requires very little space, in particular a sensor installation space of <200×200 μm, so that such a laser beam generation unit is particularly suitable for miniaturized applications. A VCSEL is also relatively inexpensive compared to conventional edge emitters and only has a low energy requirement. With respect to the measurement principle underlying the method according to the invention and also with respect to the use of VCSEL for miniaturized applications, reference is made to the paper by Pruijmboom et al. “VCSEL-based miniature laser-Doppler interferometer” (Proc. of SPIE Vol. 6908, 69080I-1-7).

In the case of a vertical cavity surface-emitting laser (VCSEL), the mirror structures are embodied as distributed Bragg reflectors (DBR). On one side of the laser cavity, the DBR reflector has a transmittance of about 18, so that the laser radiation can couple out into free space.

In a particularly preferred embodiment of the method according to the invention, a surface emitter unit is used, which comprises an integrated photodiode or possibly a plurality of photodiodes and is also referred to as ViP (VCSEL (vertical cavity surface-emitting laser) with integrated photodiode). The integrated photodiode can be used to directly analyze the backscattered or reflected laser light that interferes with the standing wave in the laser cavity. When manufacturing a corresponding surface emitter unit, the photodiode can be integrated directly during production of the laser diode, which is produced as a semiconductor component in the course of semiconductor processing, for instance.

In the case of a ViP, the photodiode is disposed on the other side of the laser resonator, so that the photodiode does not interfere with the coupling into free space. A special feature of the ViP is the direct integration of the photodiode into the lower Bragg reflector of the laser. The size is therefore largely determined by the lens being used, which enables sizes of the laser/photodiode unit <2×2 mm. The ViP can thus be integrated, for instance into smart glasses, in such a way that it is almost invisible to the user.

FIG. 2 shows a detail view of FIG. 1, which schematically shows only a section of FIG. 1.

According to FIG. 2, a LFI sensor 18-1 is disposed on an upper part 14a of the glasses frame 14 or is integrated into the glasses frame 14. In this example, the LFI sensor 18-1 is disposed, oriented and configured such that laser radiation is emitted into a reference area 20 in a first area 22 of the face outside the eyes of the user 12, namely into the eyebrow region.

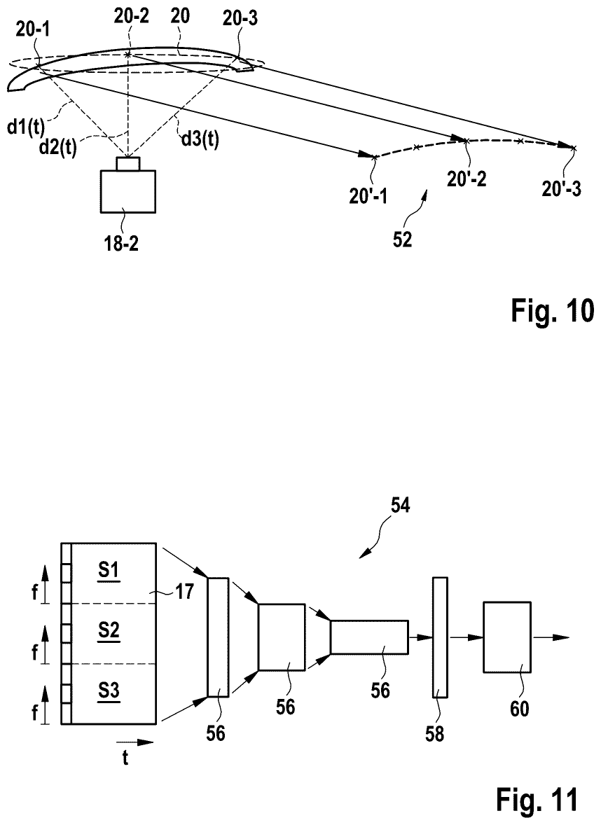

The reflected laser radiation captured by the LFI sensor 18-1 can then be used to derive information about the reference area 20 as described above. The derived information can then be used to detect movements in the area of the user's face and thus deduce a facial expression of the user. For instance, movements and/or positions of the eyebrows can be captured. A movement or position change of the eyebrows is caused by frowning, pulling the forehead up or down, eye blinking, squinting, closing or partially closing an eyelid, or movements of the upper facial muscles, for example. Thus, based on the captured movements and/or positions of the eyebrows, one of the aforementioned facial expressions and/or possibly other facial expressions can be inferred. This can also be done using a neural network. This will be explained later with reference to FIGS. 10 and 11.

According to FIG. 2, a further LFI sensor 18-2 is disposed on a lower part 14a of the glasses frame 14 or is integrated into the glasses frame. In this example, the LFI sensor 18-2, 18-5, 18-6 is disposed, oriented and configured such that laser radiation is emitted into a reference area 20 in a second area 24 of the face outside the eyes of the user 12, namely into the cheek region.

The reflected laser radiation captured by the LFI sensor 18-2 can then be used to derive information about the reference area 20 as described above. The derived information can then be used to detect movements in the area of the user's face and thus deduce a facial expression of the user. Movements in the cheek region, for instance, can be captured. A movement or position change in the cheek region is caused by laughing, squinting, closing the eyes, pressing the lips together, talking, wrinkling the nose, and other movements of the lower facial muscles, for example. Thus, based on the captured movements and/or positions in the cheek region, one of the aforementioned facial expressions and/or possibly other facial expressions can be inferred. This can also be done using a neural network.

According to the disclosure, it is provided that the LFI sensor 18 is configured to emit laser radiation into the reference area 20. This means that the LFI sensor 18 thus illuminates the reference area 20 at least partially or almost completely or completely. To enable illumination of the reference area 20, it is, for example, provided that the LFI sensor 18 comprises at least one optical element which is configured to expand a laser beam emitted by the laser light source of the LFI sensor 18 at least along a line, see FIG. 2. In this example, the reference area extends along a line 21, so that the LFI sensor illuminates the reference area at least along the line 21 by expanding the laser radiation. A line is understood to be a line that extends along a straight line. A line can alternatively also be a line that is curved or bent once or repeatedly. The expansion can also be in two or more directions. It is possible to create an illumination area having virtually any geometric shape, for instance. An illumination area can have a rectangular or approximately rectangular shape, for example, a circular shape, an elliptical shape, or any other shape. An optical element for expanding the laser beam is a lens, for example, in particular a cylinder lens or a diffractive optical element (DOE) or a holographic optical element (HOE).

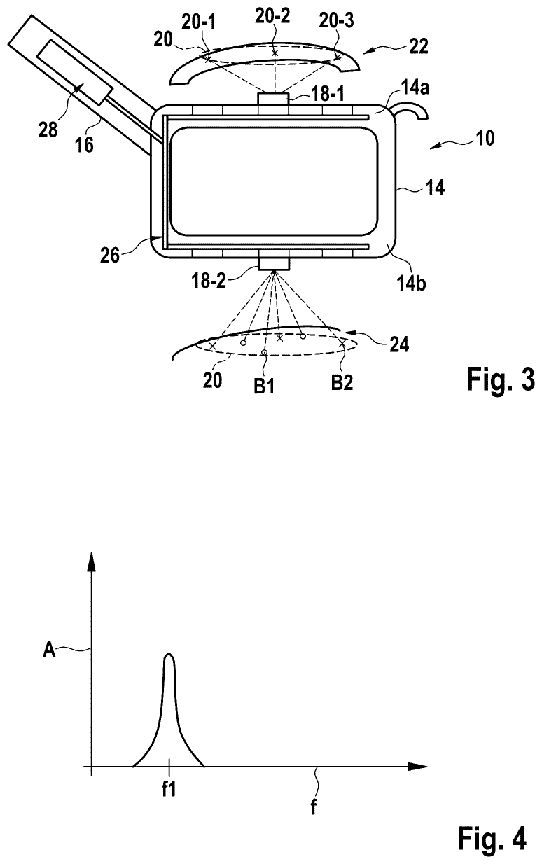

According to another embodiment, see FIG. 3, Illumination of the reference area 20 means that the LFI sensor 18 illuminates the reference area 20 at least partially, namely in such a way that a laser beam emitted by the laser light source of the LFI sensor 18 is split into at least two, in particular several, discrete subbeams, so that at least two discrete reference points within the reference area are illuminated. Light is scattered and/or reflected at each of these reference points, so that a scattered and/or reflected portion of the subbeams is captured by the LFI sensor, which results in a superposition in the distance spectrum and/or speed spectrum. A diffractive optical element (DOE), for example, or a holographic optical element (HOE), can be provided to split the laser beam into discrete subbeams. The beam can alternatively also be split by scanning the reference points using a scanning process. Examples of scanners include a microscanner comprising a movable single mirror, also known as a MEMS, or a surface light modulator comprising a mirror matrix, also known as SLM, or a reflection system based on LCOS (liquid crystal on silicon) (a technique for or an optical phase shifter. For example, FIG. 3 shows that a laser beam emitted by a LFI sensor 18-1 is split into three discrete subbeams and the subbeams illuminate three discrete reference points 20-1, 20-2, 20-3 within the reference area 20.

It can also be provided that discrete reference points can be illuminated according to at least one first illumination pattern and at least one second illumination pattern. The LFI sensor 18 can be operated in such a way that it is possible to switch between the first illumination pattern and the second illumination pattern, for example. A diffractive optical element (DOE), or a holographic optical element (HOE), for instance, can be switched between different states using electronically controllable liquid crystal. The scanners can also be used to generate different illumination patterns by controlling them accordingly. For example, FIG. 3 shows that three reference points are illuminated by means of the LFI sensor 18-2 according to a first illumination pattern B1, identified in FIG. 3 by the circles, and three reference points are illuminated according to a second illumination pattern B2, identified in FIG. 3 by the crosses. The illumination according to the illumination patterns B1 and B2 does not have to take place at the same time.

The LFI sensors 18 are almost completely or completely recessed in the frame 14 of the device 10, for example. The optics of the LFI sensor (not shown in detail) can be attached to the frame from the outside or can be recessed in the frame together with the LFI sensor 18. For advantageous assembly, it can be provided that the individual LFI sensors 18 are disposed on a common conductor device 26, for example a circuit board, a flexible circuit board or a flexible cable. In this example, the LFI sensors are connected to a central electronics unit 28 via a corresponding connection, for example by means of the flexible cable or the circuit board or another line. The central electronics unit in this example is disposed in a bracket 16 of the device 10. Other arrangements in the device 10 are possible. The central electronics unit 28 is or comprises a computing device and/or a control device, for example.

In this example, signal processing takes place in the central electronics unit 28. For instance, signal processing includes controlling and/or activating the LFI sensors 18 and/or a respective LFI sensor, 18, 18-1 to 18-4 and/or generating a driver signal for the LFI sensors 18 and/or generating a modulation signal for the LFI sensors 18 and/or reading out the interference signals acquired by a respective LFI sensor 18 and/or transforming the interference signals of the respective LFI sensors 18, for example using FFT, deriving information about the reference area 20, and possibly determining information for modulating anchor points and/or splines.

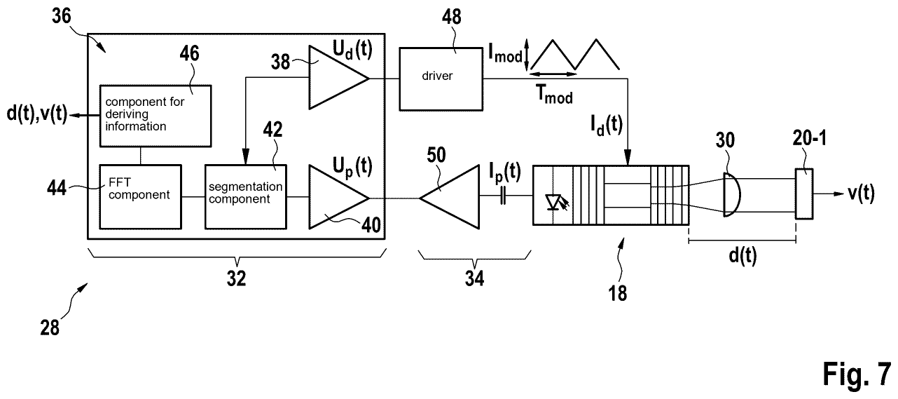

FIG. 7 shows the central electronics unit 28 and a LFI sensor 18 in the form of a VIP connected to said unit. The LFI sensor 18 in this example comprises optics 30 a collimating lens, for example. According to the illustration in FIG. 7, the central electronics unit 28 includes elements that are assigned to a digital domain 32 and elements that are assigned to an analog domain 34.

The digital domain 34 is implemented in this example as an application specific integrated circuit (ASIC) 36. Other implementations are possible, too. The circuit 36 in this example includes a D/A (digital/analog) converter 38, an A/D (analog/digital) converter 40, and an example segmentation component 42, an example FFT component 44 for transforming the interference signals, and a component 46 for deriving information about the reference area from the captured laser radiation.

In the example, a distance d (t) between the LFI sensor 18 and a reference point 20-1 and a speed v (t) at which the reference point moves are derived in a simplified manner.

The analog domain 34 in this example includes a driver 48 for the laser light source of the LFI sensor 18 and a photodiode amplifier 50 for amplifying the photocurrent Iₚ(t) of the photodiode of the LFI sensor 18.

The principle of operation of the segmentation component 42 and the FFT component is explained (again) with reference to FIGS. 8A-8D.

FIG. 8A shows a LFI sensor 18 and a reference point 20 as an example. In the example, the LFI sensor 18 comprises an integrated photodiode.

The current that drives the laser light source of the LFI sensor 18 is modulated in a ramp-like manner in this example. The photocurrent Iₚ(t) is captured by means of the LFI sensor see FIG. 8B.

The segmentation component 42 segments the time signal, the measured photocurrent Iₚ(t), with the triangular ramps of the modulation signal, referred to in this example as segment Tᵤₚ and segment T_{down}, see FIG. 8C.

The FFT is then applied to the respective segment Tᵤₚ and segment T_{down} comprising the time series data Iₚ(T), see FIG. 8D. This step is carried out in this example by the FFT component 44.

f_{b} and f_{d} are calculated according to the following mathematical relationships, for example:

$${f}_{b} = \frac{{f}_{up} + {f}_{down}}{2} and {f}_{d} = \frac{{f}_{up} - {f}_{down}}{2} ,$$

wherein

$${f}_{b} = \frac{2 {L}_{ext}}{{λ}^{2}} \frac{dλ}{dt} and {f}_{d} = \frac{2 {v}_{T}}{λ}$$

can be used to ascertain the speed V_{T} of the reference point 20-1 or the distance Lₑₓₜ of the reference point 20-1 to the LFI sensor 18.

The signal processing can also be carried out decentrally. A plurality of computing devices and/or control devices can be provided, for example. Each LFI sensor 18 can comprise its own computing device and/or its own control device, for instance. This makes it possible to carry out appropriate signal processing close to the sensor, for example; for instance control and/or modulation and/or transformation.

Components of the digital domain 32 and components of the analog domain 34 can be implemented in both the central electronics unit or individually in the individual LFI sensors.

The device 10 is configured to provide the information about the reference area 20 for the purpose of displaying a virtual target object 12′, in particular an avatar that represents the user 12 of the device 10. According to the embodiment according to FIG. 7, the device is configured for displaying the virtual target object 12′ for example. The device 10 can also be configured to specify the facial expressions of the virtual target object 12′ based on information about the reference area 20 or the reference areas 20. The virtual target object 12′ in this example is a virtual rendering of the face of the user 12.

The virtual target object 12′ can be displayed using a variety of techniques. For instance, the virtual target object 12′ can be projected onto a display or a glass of the device 10, in particular the smart glasses, for example by means of a laser. It is also possible that the virtual target object 12′ is projected into the field of view of the user of the device 10 directly onto the retina of the eye of the user 12.

The virtual target object 12′ in this example includes a plurality of “virtual” anchor points 20′. A respective anchor point 20′-1 of the virtual target object 12′ can, but does not have to, be assigned to a reference point 20-1 on the face of the user 12, for example, or associated with a reference point 20-1. An anchor point 20′ can also be associated with a plurality of reference points 20, however. One or more anchor points 20′ can also be associated with one reference area 20. If movement in a reference point or a reference area 20 is detected by means of a LFI sensor 18, for example, this movement can be reproduced in the virtual target object 12′ by modulating the corresponding anchor point 20′ or also multiple anchor points 20′. Modulating an anchor point 20′ is understood to mean changing the position of the anchor point 20′, for example. Alternatively, it can also be provided that the virtual target object 12′ comprises at least one or more splines 52. A spline is assigned to a reference area 20 or associated with a reference area, for example.

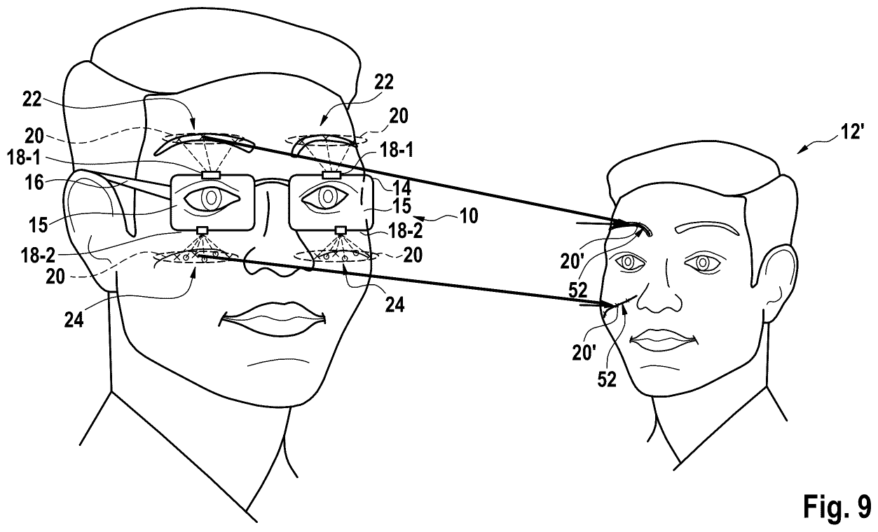

FIG. 10 shows a section of FIG. 9 as an example. The sensor 18-1 is used to derive information about the reference area 20, for example, by ascertaining the distances d₁(t), d₂(t) and d₃(t) to the reference points 20-1, 20-2, 20-3 based on reflected laser radiation.

This information is used to modulate anchor points 20′-1, 20′-2, and 20′-3, for instance. A geometric model, for example, can be used to determine positions of the anchor points 20′-1, 20′-2, and 20′-3. d₁(t), d₂(t), and d₃(t) and the known position of the respective LFI sensor 18 relative to the device 10 can be used to determine the positions of the anchor points 20′-1, 20′-2, and 20′-3 in the virtual target object 12′ relative to the position of the device 10.

A spline 52 can be calculated in this example using the determined positions of the anchor points 20′-1, 20′-2 and 20′-3 in order to selectively modulate, for instance, the eyebrow of the virtual target object 12′. The anchor points are nodes of the spline 52, for example.

Alternatively, a position of anchor points or also directly a spline can be determined from distance and speed spectra ascertained using the LFI sensors 18.

In this example, this is done using a trained neural network 54. The distance and speed spectra ascertained with the LFI sensors 18 are provided to the neural network as input data.

With a LFI sensor 18, the ascertained distance and speed spectra are similarly provided to the neural network as input data. If multiple sensors are used, it can be advantageous for the distance spectra to be provided as input data arranged in a matrix-like manner along the frequency axis f and the speed spectra along the time axis t, see FIG. 11 for example. The resolution of the time axis t corresponds to the modulation duration of a triangular modulation. The trained neural network 54 is used to derive information about the reference area or information about one or more anchor points and/or splines of the virtual target object assigned to the respective reference area from the spectra S1, S2, S3 arranged in a matrix-like manner.

In the example, the neural network is a CNN (convolutional neural network) model. The example shows three CNN layers 56. The CNN model is used to extract features from the measured distance and speed spectra arranged in a matrix-like manner that are then passed through an optional fully connected layer 58. Information about the reference points and/or information about the anchor points of the virtual object and/or information about the splines can be derived from the extracted features using a regressor 60.

The derived information can then be used to modulate the facial expressions of the target object, for example by modulating the anchor points and/or directly modulating the splines.

The use of a neural network 54 makes it possible to pretrain the feature extraction on a suitable, appropriately large data set, so that detection can be carried out in a robust manner for different face shapes and positions of the glasses and/or impact points of the sensors.

According to one embodiment, it is provided that the method comprises a learning phase for adapting the trained neural network 54 to a user 12 of the device 10, wherein the neural network 54 is adapted to the user using a camera, wherein image data recorded with the camera are used as labeled training data for adapting the neural network. The learning phase is based on few-shot learning, for example. The user can, for instance, specifically specify different facial expressions that are captured with the camera and are then available as labeled training data.

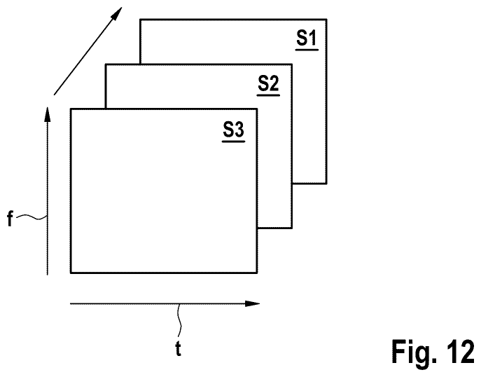

FIG. 12 shows an alternative arrangement of the input data for neural network.

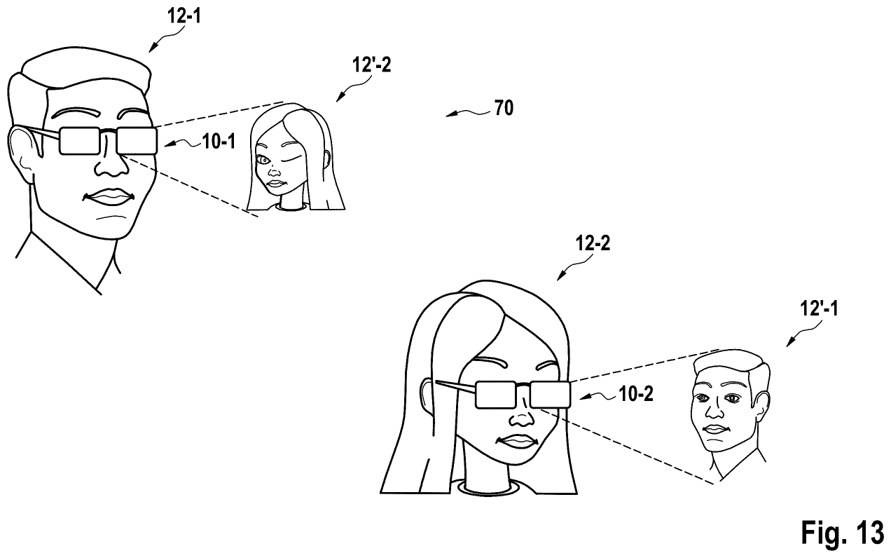

FIG. 13 shows a communication system 70 for carrying out a communication method with at least two users 12-1 and 12-2. The two users are each wearing a device 10-1, 10-2, in the example in the form of smart glasses. The two users 12-1, 12-2 can be in different locations. The devices 10-1, 10-2 each include a not further depicted communication interface that enables data exchange between the two devices 10-1, 10-2. The two devices 10-1, 10-2 are configured according to the above-described embodiments to use LFI sensors 18 to derive information about reference areas 20 in a respective face of the user 12-1, 12-2. The respective device 10-1, 10-2 provides this information to the further device 10-1, 10-2 via data transmission. The respective device 10-1, 10-2 receives the data from the further device 10-1, 10-2. Based on the received data, the respective device 10-1, 10-2 displays a virtual target object 12′-1, 12′-2 that represents the respective further user 12-1, 12-2. The respective device is configured to specify a facial expression of the virtual target object 12′-1, 12′-2 based on the data of the further device 10-1, 10-2.

1-14. (canceled)

15. A device including smart glasses, which, when worn by a user of the device as intended, is configured to be worn on a head of the user, wherein the device comprises:
at least one laser feedback interferometer (LFI) sensor with at least one laser light source including a laser diode, wherein the LFI sensor is disposed on the device and is configured to emit laser radiation into a reference area in a first area of a face outside eyes of the user of the device and to capture a reflected portion of laser radiation;
wherein the device is configured to use the reflected portion of the laser radiation to derive information about the reference area; and
wherein the device is configured to provide the information about the reference area for the purpose of displaying a virtual target object including an avatar that represents the user of the device to a further device.

16. The device according to claim 15, wherein the LFI sensor including at least one optical element which is configured to expand a laser beam emitted by the laser light source at least along a line.

17. The device according to claim 15, wherein the LFI sensor is configured such that a laser beam emitted by the laser light source is split into at least two discrete subbeams, so that at least two discrete reference points within the reference area are illuminated.

18. The device according to claim 17, wherein the device is configured such that discrete reference points can be illuminated according to at least one first illumination pattern and at least one second illumination pattern, and it is possible to switch between the first illumination pattern and the second illumination pattern.

19. The device according to claim 15, wherein the device is configured to receive data from a further device of a further user, the further device including smart glasses, wherein the data includes information about at least one reference area in at least a first area of a face of the further user, and wherein the device is configured to display a virtual target object including an avatar that represents the further user, based on the data of the further device, and wherein the device is configured to provide a facial expression of the virtual target object based on the data of the further device.

20. The device according to claim 19, wherein the device is configured such that providing the facial expression of the virtual target object includes: modulating at least one spline in a first area of the virtual target object based on the information about at least one reference area of the first area.

21. A method for operating a device including smart glasses, comprising the following steps:
emitting laser radiation into at least one reference area in a first area of a face of a user of the device and capturing a reflected portion of the laser radiation;
using the reflected portion of the laser radiation to derive information about the reference area; and
providing the information about the reference area for the purpose of displaying a virtual target object including an avatar that represents the user of the device to a further device.

22. The method according to claim 21, further comprises:
receiving data from a further device of a further user, the further device including smart glasses, wherein the data includes information about at least one reference area in at least a first area of a face of the further user;
displaying a virtual target object including an avatar that represents the further user, on the device based on the data of the further device; and
providing a facial expression of the virtual target object based on the data of the further device.

23. The method according to claim 21, wherein providing the facial expression of the virtual target object includes: modulating at least one spline in at least a first area of the virtual target object based on the information about the reference area of the first area.

24. The method according to claim 23, wherein a respective reference area is assigned to or associated with the at least one spline of the virtual target object, and the at least one spline is modulated based on the information about the respective reference area.

25. The method according to claim 21, wherein a distance spectrum and/or speed spectrum ascertained based on the reflected portion of the laser radiation captured using the at least one LFI sensor is made available as input data to at least one trained neural network and information about the reference area or information about a spline assigned to the respective reference area is derived from the distance spectrum and/or from the speed spectrum using the trained neural network and the spline of the virtual target object is modulated based on the derived information.

26. The method according to claim 25, further comprising a learning phase for adapting the trained neural network to the user of the device, wherein the neural network is adapted to the user using a camera, wherein image data recorded with the camera are used as labeled training data for adapting the neural network.

27. A communication system, comprising:
at least one first device and at least one further device, wherein each of the first device and the further device includes:
at least one laser feedback interferometer (LFI) sensor with at least one laser light source including a laser diode, wherein the LFI sensor is disposed on the device and is configured to emit laser radiation into a reference area in a first area of a face outside eyes of the user of the device and to capture a reflected portion of laser radiation;
wherein the each of the first device and the further device is configured to use the reflected portion of the laser radiation to derive information about the reference area; and
wherein the each of the first device and the further device is configured to provide the information about the reference area for the purpose of displaying a virtual target object including an avatar that represents the user of the device to the further device or the user of the further device to the device.

28. A communication method between at least two users via a communication network comprising a communication system, wherein a first user is connected to the communication network via a first terminal and the second user is connected to the communication network via a second terminal, wherein the first terminal and the second terminal are each a device
including:
at least one laser feedback interferometer (LFI) sensor with at least one laser light source including a laser diode, wherein the LFI sensor is disposed on the device and is configured to emit laser radiation into a reference area in a first area of a face outside eyes of the user of the device and to capture a reflected portion of laser radiation;
wherein the each of the first device and the further device is configured to use the reflected portion of the laser radiation to derive information about the reference area; and
wherein the each of the first device and the further device is configured to provide the information about the reference area for the purpose of displaying a virtual target object including an avatar that represents the user of the device to the further device or the user of the further device to the device;
the method comprising:
displaying at least an avatar the represents the first user on the second terminal of the second user.
